(19) United States
(12) Patent Application Publication
(10) Pub. No.: US 2024/0202492 A1
(43) Pub. Date: Jun. 20, 2024

(54) METHOD AND APPARATUS FOR TRAINING GRAPH FEDERATED LEARNING MODELS USING REINFORCEMENT LEARNING-BASED DATA AUGMENTATION

(71) Applicant: Research & Business Foundation SUNGKYUNKWAN UNIVERSITY, Suwon-si (KR)

(72) Inventors: Soyoung LEE, Suwon-si (KR); Hogun PARK, Suwon-si (KR)

(73) Assignee: Research & Business Foundation SUNGKYUNKWAN UNIVERSITY, Suwon-si (KR)

(21) Appl. No.: 18/507,289

(22) Filed: Nov. 13, 2023

(30) Foreign Application Priority Data
Dec. 14, 2022 (KR) 10-2022-0174584

(51) Int. Cl. G06N 3/04; G06N 3/084

(52) U.S. Cl. CPC G06N 3/04; G06N 3/084

(57) ABSTRACT

The present disclosure relates to a method for training a neural network model. First screening data is determined by inputting first data not associated with at least one client into the neural network model to calculate similarity between the first data and second data associated with the at least one client. the neural network model is trained by performing backpropagation on the neural network model with reference to a reward determined based on a correlation between the first screening data and the second data.

### CROSS-REFERENCE TO RELATED APPLICATION

This application claims the benefit under 35 USC § 119(a) of Korean Patent Application Number 10-2022-0174854, filed on Dec. 14, 2022, the entire disclosure of which is incorporated herein by reference for all purposes.

### BACKGROUND

### 1. Technical Field

The present disclosure relates to a method and apparatus for training a graph federated learning models using reinforcement learning-based data augmentation.

The present disclosure is associated with the BK21 FOUR Project (No. 1345330145), a research project conducted with the support of the National Research Foundation of Korea.

Further, the present disclosure is associated with the A Study on Providing Explanations for Node Representation Learning Models (No. 1711157583), a research project conducted with the support of the National Research Foundation of Korea in both 2022 and 2023.

Further, the present disclosure is associated with the Development of Brain-Body interface technology using AI-based multi-sensing (No. 1711171054), a research project conducted with the support of the National IT Industry Promotion Agency of Korea (NIPA) and funded by the Ministry of Science and ICT in 2022.

Further, the present disclosure is associated with the Development of stress visualization and quantization based on strain sensitive smart polymer for building structure durability examination platform (No. 1711158840), a research project conducted with the support of the National Research Foundation of Korea.

Further, this study is associated with the AI Graduate School Support Program (Sungkyunkwan University) (No. 1711153024), a research project conducted with the support of the Korea government (MSIT) in 2022 and funded by the Institute of Information & communications Technology Planning & Evaluation (IITP).

### 2. Description of the Related Art

Federated learning introduced for privacy protection and parallel learning has a centralization and accuracy trade-off issue in a distributed environment. This may mean that as the number of client increases and the heterogeneity of data among clients grows, accuracy decreases.

To address the issue of accuracy degradation in the federated learning environment, Data Sharing techniques have been proposed. However, the Data Sharing techniques face limitations because they may potentially expose internal data externally, which goes against the fundamental principles of federated learning. In addition, if the size of shared training data is larger than the individual clients' training data, there's a risk of clients' models overfitting to the shared data.

Therefore, in order to address the issue of accuracy degradation in the federated learning environment while also improving the speed and performance of model training, there is a need to develop methods, which increase the accuracy of individual clients through data augmentation, which strengthens the data distribution of each client using publicly available external data, and which, in turn, leads to an increase of the accuracy of a global model.

### SUMMARY

In view of the above, the present disclosure provides a model training method including: determining first screening data by inputting first data not associated with at least one client into a neural network model to calculate similarity between the first data and second data associated with the at least one client; and training the neural network model by performing backpropagation on the neural network model with reference to a reward determined based on a correlation between the first screening data and the second data.

However, the objects of the present disclosure is not limited to the aforementioned object, and other objects not mentioned may be clearly understood by those of ordinary skill in the art to which the present disclosure belongs from the following description.

In accordance with one aspect of the present disclosure, there is provided a model training method comprising: determining first screening data by inputting first data not associated with at least one client into a neural network model to calculate similarity between the first data and second data associated with the at least one client; and training the neural network model by performing backpropagation on the neural network model with reference to a reward determined based on a correlation between the first screening data and the second data.

Preferably, the neural network model includes at least one of a first model, a second model, and a third model, the first model is a model that is trained on a distribution of the first data based on a learning process that includes outputting a first embedding vector for user-item interactions based on the first data, the second model is a model that is trained on a distribution of the second data based on a learning process that includes outputting a second embedding vector for the user-item interactions based on the second data, and the third model is a model that is trained on a distribution of the first screening data based on a learning process that includes outputting a third embedding vector for the user-item interactions based on the first screening data.

Preferably, the determining of the first screening data includes: calculating a probability that the first data and the second data are similar, with reference to the first embedding vector and the second embedding vector; and determining a binary value through sampling based on the calculated probability.

Preferably, the reward is determined based on calculation on a loss value for the second data and a loss value for the first screening data.

Preferably, the method further includes in response to completion of a predetermined number of epochs, transmitting parameters of the trained neural network model to a server; and receiving updated parameters of the neural network model from the server, wherein the received parameters of the neural network model have been updated based on calculation on the parameters of the neural network model, which are received from each of a plurality of clients.

Preferably, the method further includes training the neural network model based on the received parameters of the neural network model.

In accordance with another aspect of the present disclosure, there is provided a non-transitory computer-readable storage medium including computer executable instructions, wherein the instructions, when executed by a processor, cause the processor to perform a model training method comprising: determining first screening data by inputting first data not associated with at least one client into a neural network model to calculate similarity between the first data and second data associated with the at least one client; and training the neural network model by performing backpropagation on the neural network model with reference to a reward determined based on a correlation between the first screening data and the second data.

In accordance with a still another aspect of the present disclosure, there is provided a model training apparatus comprising: a memory having a model performance improvement program stored therein; and a processor configured to load the model performance improvement program from the memory and execute the model performance improvement program, wherein the processor determines the first screening data by inputting first data not associated with the at least one client into a neural network model and calculating a similarity between the first data and second data associated with the at least one client, and wherein the processor trains the neural network model by perform backpropagation on the neural network model with reference to a reward determined based on a correlation between the first screening data and the second data.

According to an embodiment of the present disclosure, since the distribution characteristics of internal data are preserved through reinforcement learning performed on each client's recommender system model, it is possible to correct the performance degradation of the model in the federated learning environment caused by the heterogeneity of data distribution among clients.

In addition, according to an embodiment of the present disclosure, data for external specific users with preferences similar to the preferences of preferences of internal specific users for specific items may be filtered, thereby not only removing noise within the training data, but also augmenting the training data through filtering of external data.

However, effects of the present disclosure are not limited to the effects mentioned above, and other effects not mentioned will be clearly understood by those skilled in the art from the description below.

### BRIEF DESCRIPTION OF THE DRAWINGS

FIG. 1 is a block diagram illustrating a model training apparatus according to an embodiment of the present disclosure.

FIG. 2 is a block diagram conceptually illustrating the functions of a model performance improvement program according to an embodiment of the present disclosure.

FIG. 3 is a flowchart illustrating a method for training a recommender system model according to an embodiment of the present disclosure.

FIG. 4 is a flowchart illustrating a method for performing federated learning based on a recommender system model of each client according to an embodiment of the present disclosure.

### DETAILED DESCRIPTION

The advantages and features of embodiments and methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

Hereinafter, embodiments of the present disclosure will be described in detail with reference to the accompanying drawings.

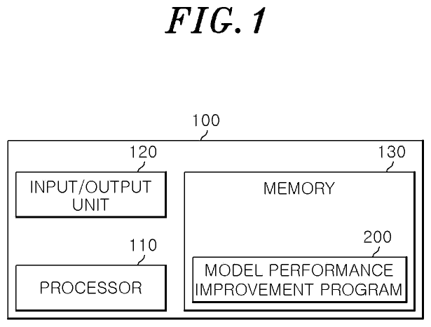

FIG. 1 is a block diagram illustrating a model training apparatus according to an embodiment of the present disclosure.

Referring to FIG. 1, a model training apparatus 100 may include a processor 110, an input/output device 120, and a memory 130.

The processor 110 may control the overall operation of the model training apparatus 100.

The processor 110 may use the input/output device 120 to receive first data not associated with at least one client and second data associated with the client.

Although it has been described that first data not associated with at least one client and second data associated with the at least one client are input through the input/output device 120, aspects of the present disclosure are not limited thereto. That is, in some embodiments, the model training apparatus 100 may include a transceiver (not shown), and the model training apparatus 100 may use the transceiver (not shown) to receive at least one of first data not associated with at least one client and second data associated with the at least one client, and at least one of the first data associated with the at least one client and the second data associated with the at least one client may be generated within the model training apparatus 100.

Here, the first data and the second data refer to data related to interactions between users and items, representing preferences for specific items by specific users. For example, the first data and the second data may refer to data related to specific items purchased by specific users or data corresponding to specific items associated with specific users' input (e.g., likes).

In addition, the first data according to an embodiment of the present disclosure may refer to data not associated with a client, such as external data that the client does not possess (e.g., data publicly available on a website). Also, the second data according to an embodiment of the present disclosure may refer to data associated with a client, such as internal data that the client possesses. Here, at least one client according to an embodiment of the present disclosure may refer to a server corresponding to each seller (or company) selling items.

The processor 110 may determine first screening data by receiving first data not associated with at least one client and second data associated with the at least one client, and then enhance the performance of a neural network model by training the neural network model with reference to a reward determined based on the first screening data and the second data.

The input/output device 120 may include one or more input devices and/or one or more output devices. For example, an input device may include a microphone, keyboard, mouse, touch screen, etc., and an output device may include a display, a speaker, etc.

The memory 130 may store a model performance improvement program 200 and information required for execution of the model performance improvement program 200.

In this specification, the model performance improvement program 200 refers to software that receives first data not associated with at least one client and second data associated with the at least one client and storing instructions required for improving the performance of the neural network model.

In order to execute the model performance improvement program 200, the processor 110 may load the model performance improvement program 200 and information required for execution of the model performance improvement program 200 from memory 130.

The processor 110 may execute the model performance improvement program 200 to improve the performance of the neural network model. Here, the neural network model according to an embodiment of the present disclosure may include at least one of a first model, a second model, and a third model.

Specifically, the first model according to an embodiment of the present disclosure may refer to a model that is trained on the distribution or features of the first data (such as the distribution or features of external data related to user-item interactions) based on a learning process that includes outputting a first embedding vector for user-item interactions based on the first data.

In addition, the second model according to an embodiment of the present disclosure may refer to a model that is trained on the distribution or features of the second data (e.g., the distribution or feature of internal data related to user-item interactions) based on a learning process that includes outputting a second embedding vector for user-item interactions based on the second data.

In addition, the third model according to an embodiment of the present disclosure may refer to a model that is trained on the distribution or feature of the first screening data (e.g., the distribution or features of external data related to user-item interactions, the data deemed to be similar to the internal data) based on a learning process that includes outputting a third embedding vector for user-item interactions based on the first screening data.

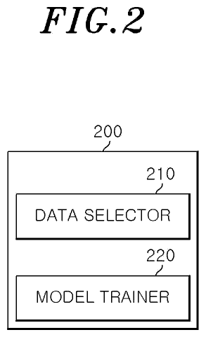

The functions and/or operations of the model performance improvement program 200 will be described in detail with reference to FIG. 2.

FIG. 2 is a block diagram conceptually illustrating the functions of a model performance improvement program according to an embodiment of the present disclosure.

Referring to FIG. 2, a model performance improvement program 200 may include a data selector 210 and a model trainer 220.

The data selector 210 and model trainer 220 shown in FIG. 2 conceptually divide the functions of the model performance improvement program 200 to easily explain the functions of the model performance improvement program 200. However aspects of the present disclosure are not limited thereto. In some embodiments, the functions of the data selector 210 and the model trainer 220 may be combined or separated and implemented as a series of instructions within a single program.

The data selector 210 may determine first screening data by inputting first data not associated with at least one client into a neural network model and calculating a similarity between the first data and second data associated with the at least one client.

Specifically, in determining the first screening data, the data selector 210 according to an embodiment of the present disclosure may calculate a probability that the first data is similar to the second data, with reference to the first embedding vector and the second embedding vector.

More specifically, the data selector 210 according to an embodiment of the present disclosure may input the first data into a first model and a second model to produce a 64×4-dimensional first embedding vector and second embedding vector containing preference information for specific items by specific users. Next, the data selector 210 may calculate a loss value for the second data from the second embedding vector (i.e., the difference between the prediction value of the second model and the actual preference) to calculate a probability that the first data is similar to the distribution of the second data (e.g., a probability or similarity that external data is similar to internal data, or a probability that external specific users have similar preferences to that of internal specific users).

In addition, the data selector 210 according to an embodiment of the present disclosure may derive a binarized value through sampling based on the calculated probability.

More specifically, the data selector 210 may determine a value of 1 or 0 through sampling following a Bernoulli distribution with the probability (for example, the probability or similarity that external data and internal data are similar) as a parameter. The first data for which a value of 1 is outputted may be determined as the first screening data.

In doing so, data for external specific users with preferences similar to the preferences internal specific users for specific item may be filtered, thereby not only removing noise within the training data, but also augmenting the training data through filtering of external data.

Next, the model trainer 220 may train the neural network model by performing backpropagation on the neural network model with reference to a reward determined based on a correlation between the first screening data and the second data.

Here, the reward may be determined based on calculation on a loss value for the second data, which is calculated using the second model, and a loss value for the first screening data, which is calculated using the third model. For example, a difference between the loss value for the first screening data (i.e., the difference between a predicted value and actual preference of the third model) and the loss value for the second data (i.e., a difference between a predicted value and actual preference of the second model) may be determined as a reward. In another example, a difference between the recall of the second model and the recall of the third model may be determined as a reward.

Specifically, the model trainer 220 according to an embodiment of the present disclosure may train the parameters of the neural network model by performing backpropagation in a direction in which the difference between the loss value for the first screening data and the loss value for the second data decreases (i.e., in a direction where the reward increases).

More specifically, the model trainer 220 according to an embodiment of the present disclosure may train the parameters of the neural network model in a direction where the difference between the loss value for the first screening data and the loss value for the second data decreases (i.e., in a direction where the reward increases) according to an algorithm adopting a policy-based action determination method, such as Policy Gradient.

Meanwhile, the model trainer 220 may transmit the trained parameters of the neural network model to the server (not shown) in response to completion of a predetermined number of epochs.

For example, the model trainer 220 may transmit the trained parameters of the neural network model to the server (not shown) in response to the completion of 10 training epochs.

In addition, the model trainer 220 may receive updated parameters of the neural network model from the server (not shown). Here, the received parameters of the neural network model according to an embodiment of the present disclosure may have been updated based on calculation on the parameters of the neural network model, which are received from each of a plurality of clients.

Specifically, in one embodiment of the present disclosure, in the server (not shown), the global parameters may be updated as a weighted arithmetic mean operation is performed on the trained parameters of the neural network model, which are received from a plurality of clients, based on the size (or number) or degree of learning of training data. The model trainer 220 may receive the updated global parameters as parameters of the neural network model.

In addition, the model trainer 220 may further train the neural network model based on the received parameters of the neural network model.

Specifically, the model trainer 220 may further train the neural network model until the global parameters updated by the server (not shown) converge.

In doing so, after the neural network model is trained for each client based on internal data of each client, the global parameters are updated by aggregating weighted arithmetic means of neural network model parameters obtained for the respective clients from the server. Subsequently, federated learning is performed so that the neural network model is trained for the respective clients based on the updated global parameters. Consequently, the performance of the neural network model for a plurality of clients may be improved. In addition, it is possible to accelerating the training speed by sharing the parameters while training.

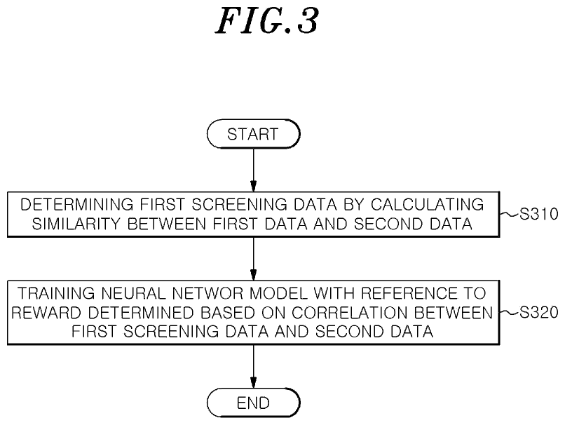

FIG. 3 is a flowchart illustrating a method for training a recommender system model according to an embodiment of the present disclosure.

Referring to FIGS. 2 and 3, in order to train a neural network model, the data selector 210 may determine the first screening data by calculating the similarity between the first data and the second data in operation S310. Here, the neural network model according to an embodiment of the present disclosure is a graph recommender system model and may include at least one Neural Graph Collaborative Filtering (NGCF) model. In addition, the first data and second data according to an embodiment of the present disclosure may refer to graph data that is expressed with nodes and edges to indicate user-item interactions.

Specifically, in determining the first screening data, the probability of similarity between the first data and the second data may be calculated with reference to the first embedding vector, where a user vectors and a positive item vector are embedded, being output in the latent space when first data not possessed by a client is input into the first model, and the second embedding vector, where a user vector and a positive item vector are embedded, being output in the latent space when second data possessed by the client is input into the second model.

More specifically, as the loss value for the second data (i.e., the difference between the predicted value of the second model and the actual preference) is calculated from the second embedding vector, the probability of similarity in distribution between the first data and the second data (e.g., the probability or similarity that external data is similar to internal data, that is, a probability that a specific external user shares similar preferences with a specific internal user) may be calculated.

In this manner, reinforcement learning of a recommender system model may be performed using graph data for which the correct answer label vector cannot be set.

Next, the model trainer 220 may train the neural network model with reference to a reward determined based on a correlation between the first screening data and the second data in operation S320. Here, the reward according to an embodiment of the present disclosure may be determined based on calculation on the loss value for the second data, calculated using the second model, and the loss value for the first screening data, calculated using the third model.

More specifically, the recommender system model may be trained (e.g., reinforcement training) in a direction where the difference between the loss value for the first screening data and the loss value for the second data decreases (i.e., in the direction where the reward increases) according to an algorithm adopting a policy-based action determination method, such as Policy Gradient.

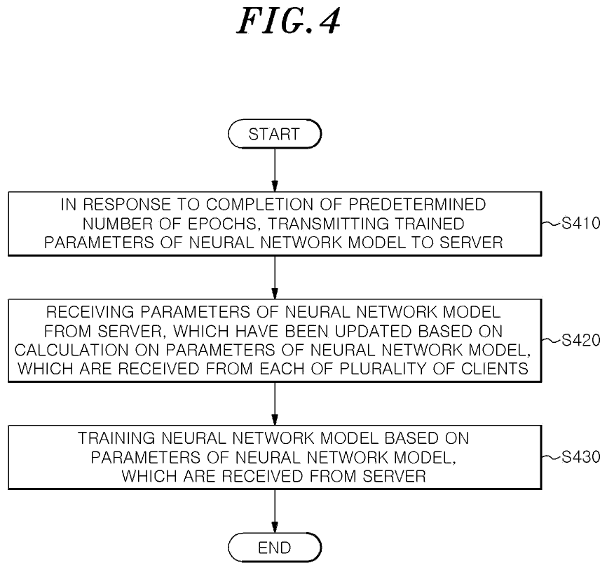

FIG. 4 is a flowchart illustrating a method for performing federated learning based on a recommender system model of each client according to an embodiment of the present disclosure.

Referring to FIGS. 2 and 4, in response to completion of a predetermined number of epochs, the processor 110 may transmit trained parameters of a neural network model to a server (not shown) in operation S410. Next, the processor 110 may receive, from the server (not shown), updated parameters of the neural network model, which have been updated based on calculation on the parameters of the neural network model parameters, which are received from each of a plurality of clients, in operation S420. Next, the processor 110 may train the neural network model based on the parameters of the neural network model parameters, which are received from the server (not shown), in operation S430.

Specifically, in response to the completion of 10 training epochs for a recommender system model for each client, local parameters of the trained recommender system model may be transmitted to the server (not shown).

In addition, global parameters of the recommender system model may be updated as a weighted arithmetic mean operation is performed on the local parameters of the recommender system model, which are received from each of the plurality of clients, based on the size or degree of learning of the training data.

In addition, in response to receiving the updated global parameters from the server, federated learning may be performed so that reinforcement learning is performed on each client's recommender system model based on the global parameters. Here, the federated learning may be performed until the global parameters converge.

As such, since the distribution characteristics of internal data are preserved through reinforcement learning performed on each client's recommender system model, it is possible to correct the performance degradation of the model in the federated learning environment caused by the heterogeneity of data distribution among clients.

Combinations of each block of the block diagrams and each step of the flowchart attached to the present disclosure may be performed by computer program instructions. Since these computer program instructions can be installed in an encoding processor of a general-purpose computer, a special-purpose computer, or other programmable data processing equipment, the instructions executed through the encoding processor of the computer or other programmable data processing equipment generate means for executing functions described in each block of the block diagrams or each step of the flowchart. These computer program instructions may also be stored in a computer-usable or computer-readable memory that can be directed to computers or other programmable data processing equipment to implement functions in a particular way, and thus the instructions stored in the computer-usable or computer-readable memory can also produce manufactured items containing instruction means for executing the functions described in each block of the block diagram or each step of the flowchart. Since the computer program instructions can also be installed in a computer or other programmable data processing equipment, a series of operational steps may be performed on the computer or other programmable data processing equipment to create a process that is executed by the computer, thereby providing steps for executing the functions described in each block of the block diagrams and each step of the flowchart through the instructions.

Additionally, each block or each step may represent a module, a segment, or some code that includes one or more executable instructions for executing specified logical function(s). Additionally, it should be noted that, in some alternative embodiments, the functions mentioned in blocks or steps are executed out of order. For example, two blocks or steps shown in succession may be performed substantially simultaneously, or the blocks or steps may sometimes be performed in reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A model training method comprising:
determining first screening data by inputting first data not associated with at least one client into a neural network model to calculate similarity between the first data and second data associated with the at least one client; and
training the neural network model by performing backpropagation on the neural network model with reference to a reward determined based on a correlation between the first screening data and the second data.

2. The model training method of claim 1, wherein:
the neural network model includes at least one of a first model, a second model, and a third model,
the first model is a model that is trained on a distribution of the first data based on a learning process that includes outputting a first embedding vector for user-item interactions based on the first data,
the second model is a model that is trained on a distribution of the second data based on a learning process that includes outputting a second embedding vector for the user-item interactions based on the second data, and
the third model is a model that is trained on a distribution of the first screening data based on a learning process that includes outputting a third embedding vector for the user-item interactions based on the first screening data.

3. The model training method of claim 2, wherein the determining of the first screening data includes:
calculating a probability that the first data and the second data are similar, with reference to the first embedding vector and the second embedding vector; and
determining a binary value through sampling based on the calculated probability.

4. The model training method of claim 2, wherein the reward is determined based on calculation on a loss value for the second data and a loss value for the first screening data.

5. The model training method of claim 1, further comprising:
in response to completion of a predetermined number of epochs, transmitting parameters of the trained neural network model to a server; and
receiving updated parameters of the neural network model from the server,
wherein the received parameters of the neural network model have been updated based on calculation on the parameters of the neural network model, which are received from each of a plurality of clients.

6. The model training method of claim 5, further comprising: training the neural network model based on the received parameters of the neural network model.

7. A model training apparatus comprising:
a memory having a model performance improvement program stored therein; and
a processor configured to load the model performance improvement program from the memory and execute the model performance improvement program,
wherein the processor determines the first screening data by inputting first data not associated with the at least one client into a neural network model and calculating a similarity between the first data and second data associated with the at least one client, and
wherein the processor trains the neural network model by perform backpropagation on the neural network model with reference to a reward determined based on a correlation between the first screening data and the second data.

8. The model training apparatus of claim 7, wherein:
the neural network model includes at least one of a first model, a second model, and a third model,
the first model is a model that is trained on a distribution of the first data based on a learning process that includes outputting a first embedding vector for user-item interactions based on the first data,
the second model is a model that is trained on a distribution of the second data based on a learning process that includes outputting a second embedding vector for the user-item interactions based on the second data, and
the third model is a model that is trained on a distribution of the first screening data based on a learning process that includes outputting a third embedding vector for the user-item interactions based on the first screening data.

9. The model training apparatus of claim 8, wherein the processor calculates a probability that the first data and the second data are similar, with reference to the first embedding vector and the second embedding vector, and determines a binary value through sampling based on the calculated probability.

10. The model training apparatus of claim 8, wherein the reward is determined based on calculation on a loss value for the second data and a loss value for the first screening data.

11. The model training apparatus of claim 7, wherein the processor, in response to completion of a predetermined number of epochs, transmits parameters of the trained neural network model to the server and receives updated parameters of the neural network model from the server,
wherein the received parameters of the neural network model have been updated based on calculation on the parameters of the neural network model, which are received from each of a plurality of clients.

12. The model training apparatus of claim 11, wherein the processor further trains the neural network model based on the received parameters of the neural network model.

13. A non-transitory computer-readable storage medium including computer executable instructions, wherein the instructions, when executed by a processor, cause the processor to perform a model training method comprising:
determining first screening data by inputting first data not associated with at least one client into a neural network model to calculate similarity between the first data and second data associated with the at least one client; and
training the neural network model by performing backpropagation on the neural network model with reference to a reward determined based on a correlation between the first screening data and the second data.

14. The non-transitory computer-readable storage medium of claim 13, wherein:
the neural network model includes at least one of a first model, a second model, and a third model,
the first model is a model that is trained on a distribution of the first data based on a learning process that includes outputting a first embedding vector for user-item interactions based on the first data,
the second model is a model that is trained on a distribution of the second data based on a learning process that includes outputting a second embedding vector for the user-item interactions based on second data, and
the third model is a model that is trained on a distribution of the first screening data based on a learning process that includes outputting a third embedding vector for the user-item interactions based on the first screening data.

15. The non-transitory computer-readable storage medium of claim 14, wherein the determining of the first screening data includes:
calculating a probability that the first data and the second data are similar, with reference to the first embedding vector and the second embedding vector; and
determining a binary value through sampling based on the calculated probability.

16. The non-transitory computer-readable storage medium of claim 14, wherein the reward is determined based on calculation on a loss value for the second data and a loss value for the first screening data.

17. The non-transitory computer-readable storage medium of claim 13, wherein the method further comprises:
in response to completion of a predetermined number of epochs, transmitting parameters of the trained neural network model to a server; and
receiving updated parameters of the neural network model from the server,
wherein the received parameters of the neural network model have been updated based on calculation on the parameters of the neural network model received from each of a plurality of clients.

18. The non-transitory computer-readable storage medium of claim 17, wherein the method further comprises training the neural network model based on the received parameters of the neural network model.
